(19) United States
(12) Patent Application Publication
(10) Pub. No.: US 2004/0114354 A1
(43) Pub. Date: Jun. 17, 2004

(54) Light emitting source, printed circuit board and power source combination and its method of use

(76) Inventor: Rajendra Jagad, Hollywood, FL (US)

Correspondence Address: Rajendra Jagud, 2319 Adams Street #22-A, Holloywood, FL, 33020, US

(21) Appl. No.: 10/659,166

(22) Filed: Sep. 10, 2003

Related U.S. Application Data
(60) Provisional application No. 60/410,019, filed on Sep. 10, 2002.

(51) Int. Cl. F21L 4/02

(52) U.S. Cl. 362/122; 362/231; 362/234; 362/194

(57) ABSTRACT

Integration and Interconnection of light emitting source, printed circuit board and power source such that it can be used as for decorations by itself or with another product or can be used as signaling device or for communication between two living creatures. This Integration (assembly) can be flexible and scalable (configurable) or can be fixed and non-scalable. The primary components are Light emitting source, printed circuit board and power module and secondary components are inter-connectors like sockets, switches, wireless switches, remote control, wired switches, wires, magnets, etc. or any other device added to the primary component to create a new design for the patented method of use.

### CROSS REFERENCE TO RELATED APPLICATIONS

The present application claims the priority of provisional patent application serial No. 60/410,019, filed on Sep. 10, 2002, inventor and applicant Rajendra Jagad.

### FIELD OF THE INVENTION

This invention relates to methods of decorating an object or subject or group of objects or group of subjects using a light device.

### BACKGROUND OF THE INVENTION

Adding a light to any object is a very old concept; most of this older concept uses conductors, connections, (commonly metal wires) one or more light emitting sources (commonly light bulbs) and a power source (commonly an electrical outlet AC or DC). U.S. Pat. No. 5,489,452 uses a combination of a Christmas tree and lights with no integrated circuit. U.S. Pat. No. 5,456,032 uses a self-sufficient blinking LED to create variation in on and off sequence of the LED. This is similar to U.S. Pat. No. 3,975,659, which works on a principal of heat and temperature to provide variation in the on and off state of the light. U.S. Pat. No. 6,575,595 does not use a printed circuit board and an LED but rather uses a light bulb and wires and a wall outlet for an AC power source. That patent is more focused on the layout of a bulb and its arrangements calling it a circuit used for decorating an object. U.S. Pat. No. 5,577,832 discloses a method of use for manufacturing used not for decoration of an object and hence does not need variations in behavior pattern of the lights. Design U.S. Pat. Nos. 429,365, 432,449 and 432,046 are used in the market today to provide decorations of floral arrangements and gift items, but no integrated circuit on a printed circuit board is provided. The arrangements in accordance with Design U.S. Pat. Nos. 429,365, 432,449, and 432,046 cause a lot of power drain and do not offer the opportunity to add variation to a light emitting source.

### SUMMARY OF THE INVENTION

An observation was made in 1965 by Gordon Moore, co-founder of Intel (trademarked), that the number of transistors per square inch on integrated circuits had doubled every year since the integrated circuit was invented. Moore predicted that this trend would continue for the foreseeable future. In subsequent years, the pace slowed down a bit, but data density has doubled approximately every eighteen months, and this is the current definition of Moore's Law, which Moore himself has blessed. Most experts, including Moore himself, expect Moore's Law to hold for at least another two decades.

The present invention in one or more embodiments takes advantage of Moore's Law and the usefulness of integrated circuits and introduces light emitting sources to do complex variations in color of light, intensity of light and on and off sequence and complex combination and sequencing of such behavior pattern. Using three primary components namely the integrated circuit design printed on a printed circuit board, a light emitting source or sources, and a power supply one can add an infinite number of variation patterns to the light emitting source or sources. It can even be made modular to manually change the variation of light by just changing the socket one or more of the light-emitting sources are placed in. By alternating the three primary components, different behavior in a light emitting source or sources can be brought about and a desired lighted decoration can be added to an object or a subject or group of object or subjects.

An apparatus is disclosed which provides integration and Interconnection of one or more light emitting sources (such as light emitting diodes (LEDs), a printed circuit board and a power source. The apparatus can be used for decorations by itself or with another product or the apparatus can be used as a signaing device or for communication between two living creatures. The printed circuit board typically has an integrated circuit to control and drive one or more light sources (such as LEDs). The integrated circuit can control the color and the light intensity and the on-off timing sequence of the each of the light sources.

In one embodiment, an apparatus is provided comprising a light emitting source having at least two terminals; a portable power source; and a printed circuit board containing an integrated circuit. The light emitting source, portable power source and the printed circuit board can be combined in a first configuration such that the light emitting source is in a first state. The light emitting source, portable power source, and the printed circuit board can be combined in a second configuration such that the light emitting source is in a second state, wherein the first state differs from the second state. In the first state the light emitting source may emit light of a first color. In the second state the light emitting source may emit light of a second color.

The apparatus may further include an attachment device for attaching the light emitting source, portable power source, and printed circuit board to an object. The the object may be a plant.

### BRIEF DESCRIPTION OF THE DRAWINGS

FIG. 1A shows a front view of an apparatus in accordance with a first embodiment of the present invention;

FIG. 1B shows a top view of the apparatus of FIG. 1A;

FIG. 1C shows a bottom view of the apparatus of FIG. 1A without a power source;

FIG. 1D shows a bottom view of the apparatus of FIG. 1A with the power source;

FIG. 2A shows a front view of another apparatus in accordance with another embodiment of the present invention;

FIG. 2B shows a top view of the apparatus of FIG. 2A;

FIG. 2C shows a bottom view of the apparatus of FIG. 2A without a power source;

FIG. 2D shows a bottom view of the apparatus of FIG. 2B with the power source in FIG. 2A;

FIG. 3A shows a front view of another apparatus in accordance with another embodiment of the present invention;

FIG. 3B shows a top view of the apparatus of FIG. 3A;

FIG. 4A shows a front view of another apparatus in accordance with another embodiment of the invention.

FIG. 4B shows a holding mechanism of the apparatus shown in FIG. 4A;

FIG. 4C shows a holding mechanism of the apparatus shown in FIG. 2A;

FIG. 4D shows another holding mechanism of the apparatus shown in FIG. 4A; and

FIG. 4E shows another holding mechanism of the apparatus shown in FIG. 1A.

### DETAILED DESCRIPTION OF THE DRAWINGS

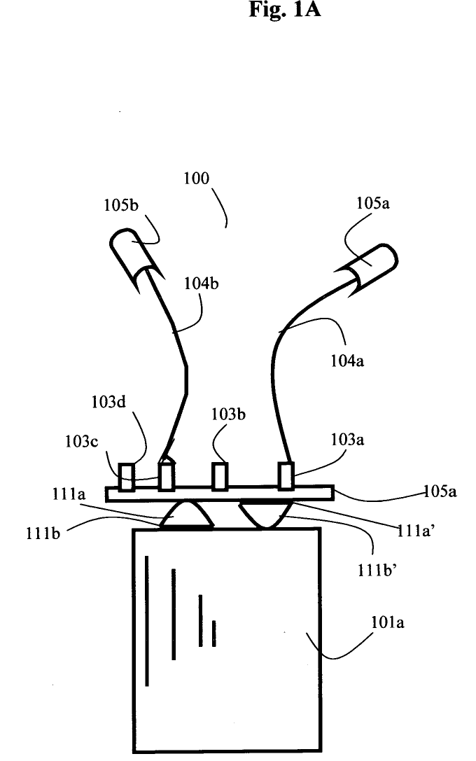

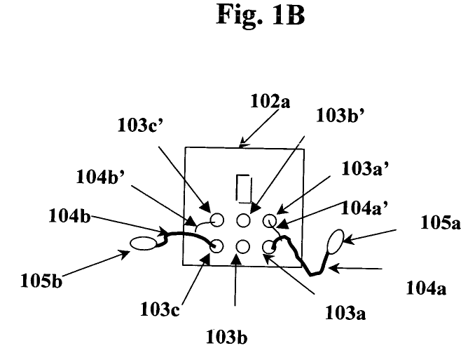

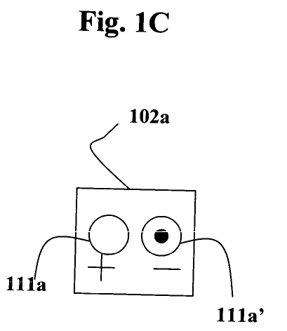

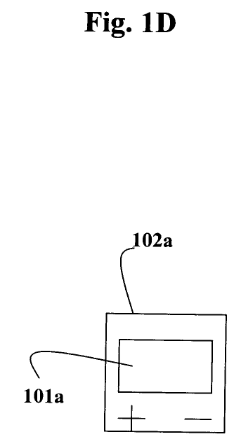

FIG. 1A shows a front view of an apparatus 100 in accordance with an embodiment of the present invention. The apparatus 100 is comprised of a power supply 101a, a printed circuit board 102a, connecting sockets 103a, 103b, and 103c, 103a′, 103b′, and 103c′ (shown in FIG. 1B) wires 104a and 104b, 104a′ and 104b′ (shown in FIG. 1B) and light illuminating sources (LEDs) 105a to 105b. The power supply 101a has terminals 111b and 111b′ which are connected to terminals 111a and 111a′, respectively, of the printed circuit board 102a. The printed circuit board 102a includes an integrated circuit. Each of the light emitting sources 105a-105b and other LEDs to be described in later FIGS., has two terminals which are connected to wires for providing electric current. FIG. 1B shows a top view of the apparatus 100. Current flows from the battery 101a to the positive terminal 111b to the positive terminal 111a to the printed circuit board 102a to the socket 103a through the wire 104a to the light emitting source 105a. The current illuminates the light emitting source 105a when the current flows through the light emitting source 105a. From the light emitting source 105a, the current goes back to the socket 103a′ shown in FIG. 1B which is grounded through the terminal 111a′ connector or terminal to the negative terminal 111b′ of the battery or power supply 101a. Thus there is a complete circuit. FIG. 1C is a bottom view of the printed circuit board 102a without the power supply 101a and FIG. 1D is a bottom view with the power supply 101a installed onto the printed circuit board 102a.

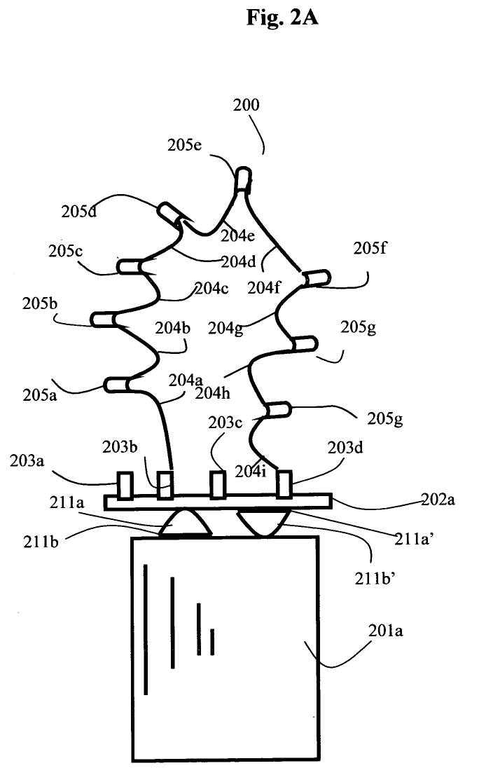

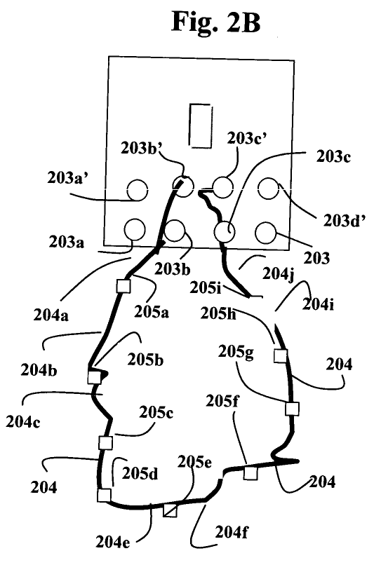

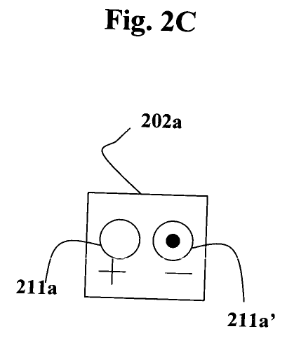

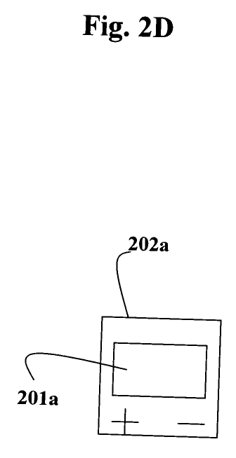

FIG. 2A shows an apparatus 200 in accordance with an embodiment of the present invention. The apparatus 200 is comprised of a power supply 201a, a printed circuit board 202a, connecting sockets 203a, 203b, 203c, and 203d, connecting sockets 203a′, 203b′, 203c′, and 203d′ (shown in FIG. 2B) wires 204a-204i, and light illuminating sources (LEDs) 205a to 205h. Power supply 201a includes positive terminal 211b and negative terminal 211b′. The printed circuit board 202a includes an integrated circuit. Note that connecting wire 204a into socket 203b, as shown in FIG. 2A, electrically connects the wire 204a with the terminal 211a which is electrically connected to the terminal 211b of the power source 201a. Connecting wire 204i into the socket 203c, as shown in FIG. 2A, electrically connects the wire 204i with the terminal 211a′ of the circuit board 202a, which is connected to the terminal 211b′ of the power source 201a. A closed circuit is thus formed, i.e. current flows from the power source 201a to the terminal 211b to the terminal 211a, to the circuit board 202a, to the socket 203b, to the wire 204a, to the LED 205a to the wire 204b, to the LED 205b, to the wire 204c, to the LED 205c, to the wire 204d, to the LED 205d, to the wire 204e, to the LED 205e, to wire the 204f, to the LED 205f, to the wire 204g, to the LED 205g, to the wire 204h, to the LED 205h, to the wire 204i, to the socket 203c, to the circuit board 202a, to the terminal 211a′ and to the terminal 211b′ of the power source 201a.

Each of sockets 203a-203d shown in FIG. 2A and each of sockets 203a′-203d′ connects to one of the two terminals 211a or 211a′, which connects to terminals 211b and 211b′, respectively, of the power source 201a. In this manner, connecting wire 204a to one of the two terminals 211a or 211a′ and simultaneously connecting wire 204i to the other of the terminal 211a′ or 211a causes a closed circuit to be formed.

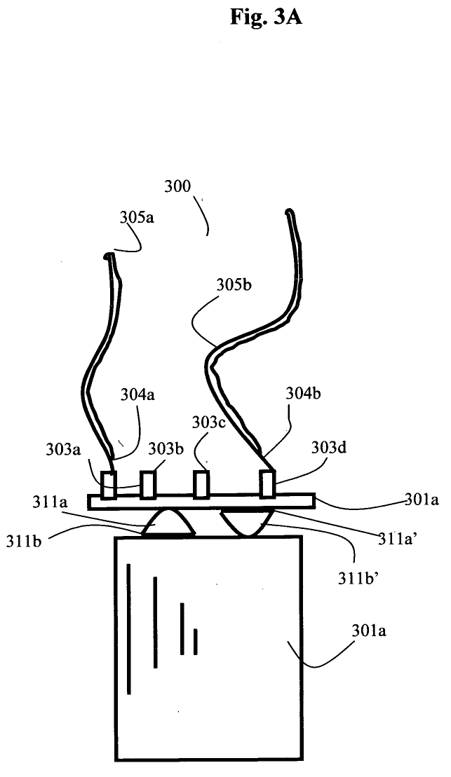

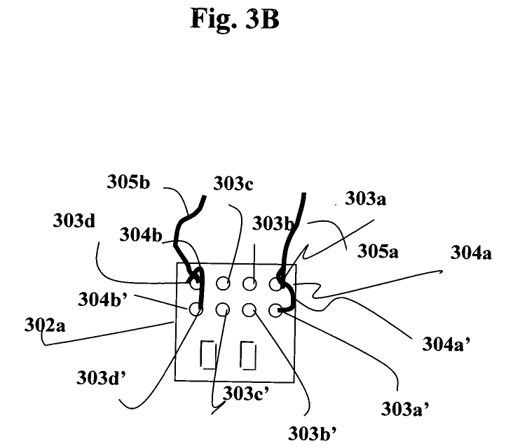

FIGS. 3A-3B shows a front view and a top view, respectively, of an apparatus 300 in accordance with an embodiment of the present invention. The apparatus 300 is comprised of power supply 301a, a printed circuit board 302a, connecting sockets 303a, 303b, 303c, and 303d, connecting sockets 303a′, 303b′, 303c′, and 303d′ (shown in FIG. 3B) wires 304a-304b, wires 304a′ and 304b′ (shown in FIG. 3B) and tubes 305a and 305b. The printed circuit board 302a includes an integrated circuit. The electrical current flows from terminal 301b of the battery or power source 301a to terminal 311a connected to the printed circuit board 302a. From there the current goes to socket 303a into the wire 304a into the flexible florescent color tube 305a and back into the wire 304a′ (shown on FIG. 3B) into the socket 303a′ into the printed circuit board 302a, into terminal 311a′, into terminal 311b′, and back to ground of the battery power source 301a to complete a circuit.

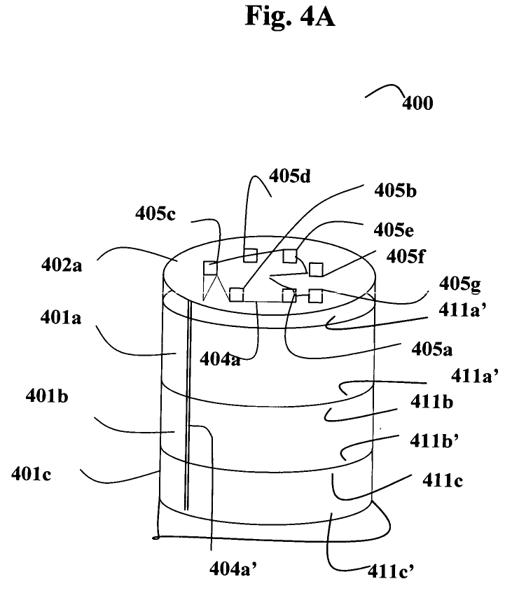

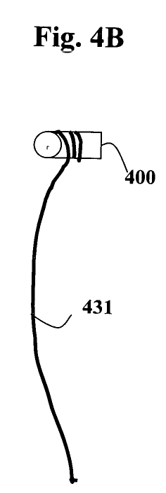

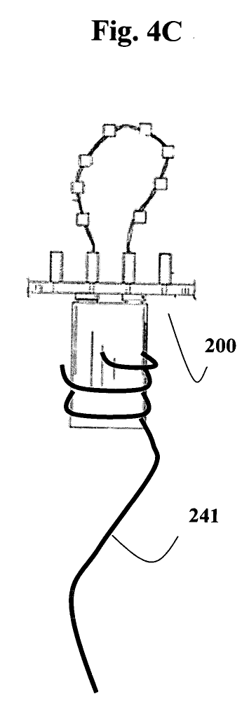

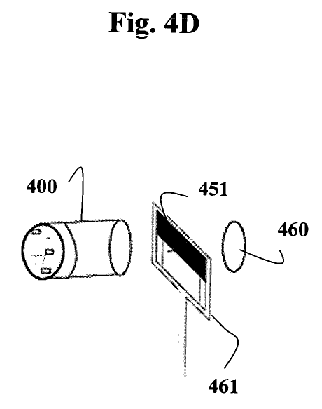

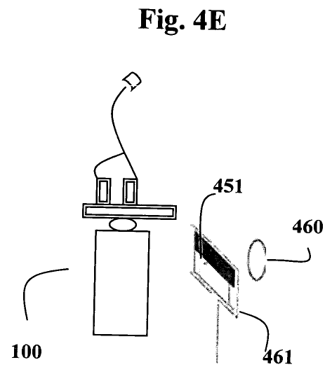

There may be any number of LEDs instead of LEDs 105a-b or LEDs 205a-h. There may be any number of power supplies instead of power supply 101a, 201a, or 301a. The circuit boards 102a, 202a, and 302a may be designed in many different ways. Each of the circuit boards 102a, 202a, 302a 402a may be or may be comprised of, for example, a flasher circuit, a flip-flop circuit, or other circuits that enable one to add variation to the light emitting source. Any kind of power supply can be used for power supply 101a, 201a, or 301a or multiple power supplies can be supplied as shown in FIG. 4A.

FIG. 4A shows a front view of an apparatus 400 in accordance with another embodiment of the invention. The apparatus 400 includes power sources 401 a, 401b, and 401c. Each of the power sources, 401-c may be a battery cell, watch battery cell, fuel cell, hydrogen cell etc . . . The apparatus 400 includes LEDs 405a, 405b, 405c, 405d, 405e, 405f, and 405g. The apparatus 400 includes a printed circuit board 402a which includes an integrated circuit. The apparatus 400 includes wires, such as wire 404a which is part of a series of wires which electrically connect the LEDs 405a-g in a similar manner as in the embodiments of FIGS. 1A-3B.

The LEDs of any of the embodiments can be two terminal or multiple terminal LEDs. LEDs 105a-b or 205a-h or light emitting florescent tubes 305a and 305b may be arranged in any shape or form desired.

In accordance with an embodiment of the present invention, placing LEDs in different positions in a circuit board, such as circuit boards 102a, 202a, or 302a, causes different behavior patterns. For example, placing wire 204a in FIG. 2A into socket 203c and placing wire 204i into socket 203b may cause the LEDs 205a-205h to emit a red blinking light, while placing wire 204i into socket 203c and at the same time placing wire 204a into socket 203b may cause the LEDs 205a-h to blink a yellow light. Placing the wire 204a into socket 203a and placing the wire 204i into socket 203b may cause the LEDs 205a-h to alternately blink red and yellow.

According to Moore's law it is possible to encapsulate the LEDs into a printed circuit board and this provides a new design. In the embodiment of FIG. 4A the electrical current flows from the power source 401a to the printed circuit board 402a directly connected to the power source 401a. The power source 401a is electrically connected to the another power source 401b via ground terminal of 411a′ of the battery 401a the which is electrically connected to the power source 401c via the ground terminal 411b′ of the watch battery 411b, which is electrically connected to the power source 404a′ via the ground terminal of the battery 411c′. The negative terminal 411a′ is grounded which again connects back to the printed circuit board 402a. The LEDs 405a-405g can be surface mount LEDs that are mounted into the printed circuit board 402a.

Current flows from power source 401a to the printed circuit board 402a to the conductor or trace conductor 404a on the printed circuit board 402a to the surface mount LED 405a back to the printed circuit board 402a through trace route or trace conductor 404a′ to the ground connection 411c′ of the power source 401a. The circuit is thus complete and a small miniature printed circuit board is provided by circuit board 401a in which many LEDs (such as LEDS 405a-g) can be placed in a desired sequence using the desired integrated circuit on the printed circuit board 402a. As technology grows more and more features can be added without increasing the size of the printed circuit board 402a according to the Moore's Law.

FIG. 4B shows a holding mechanism or attachment device for apparatus 400 using a thick flexible metal wire 431. FIG. 4C shows a holding mechanism for apparatus 200 using a thick flexible metal wire 241. The metal wire 241 can be to tied it to an object or a subject that needs to be decorated with apparatus 200. FIG. 4D shows another mechanism and/or method of holding or attaching the apparatus 400 using a magnetic disk 460. The apparatus 400 can be easily placed into a card holder 461 containing a metal plate 451. Here the card holder 461 is an object and the metal plate 451 is an aid to hold the apparatus 400 to this object. (Card holder 461). FIG. 4E shows the same holding mechanism as in FIG. 4D. However this time the holding mechanism holds the apparatus 100. This particular mechanism allows one to hook up any of the apparatus 100, 200, 300, or 400 very easily to any object. No twisting of wire is required and one of the apparatus can be worn by a subject by placing the magnetic disk 460 underneath a piece of clothing to be worn by an individual and by placing the appropriate apparatus (such as one of 100, 200, 300, or 400) outside the piece of clothing to be worn by an individual.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising
a light emitting source having at least two terminals;
a portable power source; and a printed circuit board containing an integrated circuit;
wherein the light emitting source, portable power source and the printed circuit board can be combined in a first configuration such that the light emitting source is in a first state, and wherein the light emitting source, portable power source and the printed circuit board can be combined in a second configuration such that the light emitting source is in a second state, wherein the first state differs from the second state.

2. The apparatus of claim 1 wherein
in the first state the light emitting source emits light of a first color; and
in the second state the light emitting source emits light of a second color.

3. The apparatus in claim 1 further comprising
an attachment device for attaching the light emitting source, portable power source, and printed circuit board to an object.

4. The apparatus of claim 3 wherein
the object is a plant.

5. A method comprising the steps of
attaching an apparatus to a object;
wherein the apparatus is comprised of
a light emitting source;
a printed circuit board; and
and a power source;
wherein the light emitting source, portable power source and the printed circuit board can be combined in a first configuration such that the light emitting source is in a first state, and wherein the light emitting source, portable power source and the printed circuit board can be combined in a second configuration such that the light emitting source is in a second state, wherein the first state differs from the second state.

6. The method of claim 5 wherein
the object is a live floral arrangement.

7. The method of claim 6 wherein
the object is a live plant.

8. The method of claim 6 wherein
the object is an artificial plant.

9. The method of claim 6 wherein
the object is an artificial floral arrangement.

10. The method of claim 6 wherein
the object is a Christmas tree.

11. The method of claim 6 wherein
the object is a gift container.

12. The method of claim 6 wherein
the object is a person.

13. The method of claim 6 wherein
the object is a gift item.

14. The method of claim 6 wherein
the object is a gift wrap

15. The method of claim 6 where in
the object is a candy arrangement.

16. The method of claim 6 wherein
the object is a animal.

17. The method of claim 6 wherein
the object is a display unit.

18. The method of claim 6 wherein
the object is a card holder
